(19) United States
(12) Patent Application Publication
(10) Pub. No.: US 2009/0269632 A1
(43) Pub. Date: Oct. 29, 2009

(54) APPARATUS AND METHOD FOR MOISTURIZING A GAS FLOW FLOWING TO A FUEL CELL

(75) Inventor: Stefan M. Senft, Holzheim (DE)

Correspondence Address: PATENT CENTRAL LLC;Stephan A. Pendorf, 1401 Hollywood Boulevard, Hollywood, FL, 33020, US

(73) Assignee: Daimler AG, Stuggart (DE)

(21) Appl. No.: 12/439,573

(22) PCT Filed: Aug. 7, 2007
(86) PCT No.: PCT/EP07/06960

§ 371 Date: Mar. 2, 2009

(30) Foreign Application Priority Data
Sep. 4, 2006 (DE) 10 2006 041 762.3

(51) Int. Cl. H01M 8/04; H01M 2/02

(52) U.S. Cl. 429/17; 429/34

(57) ABSTRACT

An apparatus or a method serves for humidifying a gas flow flowing to a fuel cell. A humidifier and a bypass line passed around the humidifier are thereby present. The gas flow is partially passed around the humidifier and partially through the bypass line, so that an appropriate humidity level adjusts itself in the gas flow when it has been mixed again. In order to realize this, at least one valve is arranged either in the bypass line and/or in the area of the humidifier. This valve can be switched in a clock form between two positions, specifically an open position and a closed position.

The invention relates to an apparatus for humidifying a gas flow flowing to a fuel cell with a humidifier and a bypass line passed around the humidifier according to the type defined in more detail in the preamble of claim 1, and to a method for humidifying a gas flow flowing to a fuel cell with a humidifier and a bypass line passed around the humidifier according to the type defined in more detail in the preamble of claim 3.

It is known from the generic U.S. Pat. No. 6,106,964 to humidify the gas flowing to a fuel cell by means of a humidifier, here by means of the humid exhaust gas from the fuel cell. So as not to introduce humid gas into the fuel cell in certain operating conditions, a switchable bypass line is present, by means of which the gas to be humidified can be passed around the humidifier.

It is thereby disadvantageous that always either only humid or dry gas is available.

In U.S. Pat. No. 6,884,534, it is also described how the supply air to a fuel cell is humidified. A humidifier is also present here, which can be bypassed by means of a bypass line. So as to be able to adjust the humidity to a given value, the air is passed through the humidifier and/or the bypass line in a corresponding amount and is mixed again prior to the entry into the cathode of the fuel cell. The regulation of the air amounts through/around the humidifier takes place by means of a throttle valve or a proportional valve. The air stream is thereby divided between the bypass line and the humidifier in dependence on the measured gas humidity.

These approaches have the disadvantage that the distribution of the air takes place via expensive, elaborately operated, essentially mechanical throttle elements and/or proportional valves, which are correspondingly susceptible to faults.

It is thus the object of the invention to create a simple, economic and reliable system for the humidification of gases flowing to a fuel cell.

This is achieved according to the invention by the apparatus described in claim 1.

It is the main advantage of the apparatus according to the invention that a comparatively simple and economic valve can be used instead of a movable valve or a baffle susceptible to faults, which valve only knows the closed position and the open position. Due to the fact that this valve can be switched in a clock form, an amount of gas corresponding to the clock rate can pass through the valve, so that a given volume flow can be adjusted in the time average. With such a digital activation of the valve, for example by means of a signal switched in clock form, the clock frequency of which is given corresponding to the desired flow rate amount, a very economic assembly can be produced, and which can be realized easily by means of common digital control devices.

A method according to claim 3 also solves the above-mentioned object.

The above-mentioned embodiments are correspondingly valid for the method. A part of the dry gas to be humidified and also a part of the humidity suppliers can thereby be passed around the humidifier in a bypass line. Corresponding to the clock signal of the valve, a suitable flow rate then adjusts itself in the humidifier, so that, after the humidifier, the desired humidity in the mixed gas flow can be adjusted simply without further ado either by the mixture of humidified and non-humidified gas, or the humidity amount specifically passed through the humidifier.

Both described versions of the bypass line can in principle be combined with one another.

According to a particularly advantageous arrangement of the method according to the invention, the clock frequency and/or the clock/pause ratio of the valve operation is given in a variable manner in dependence on a parameter.

This parameter can for example be the humidity of the gas flow or also a value characterizing the fuel cell itself, as for example the power output or the like. The humidification can also correspondingly be given via a variation of the clock frequency or via a pulse width-modulated activation of the valve switched in clock form.

Further advantageous arrangements of the invention result from the further dependent claims and are explained by means of the embodiments. These embodiments are shown in the following with the help of the figures.

It is thereby shown:

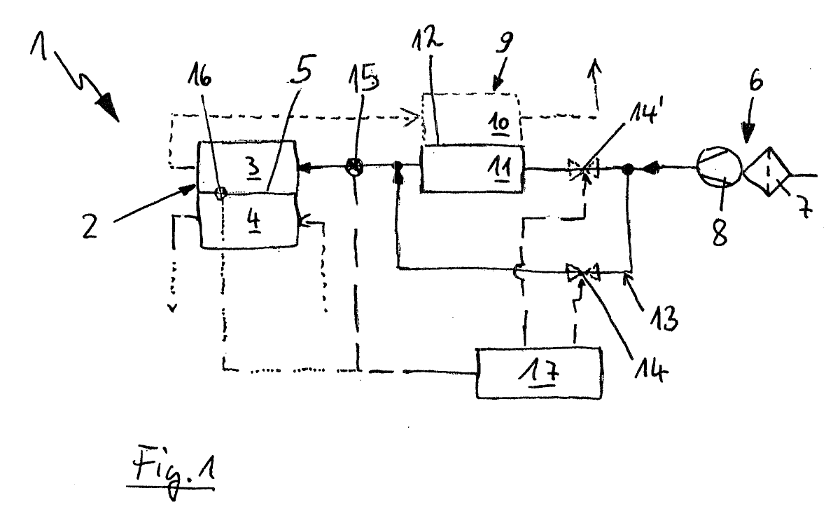

FIG. 1 a section of a fuel cell system relevant for the invention; and

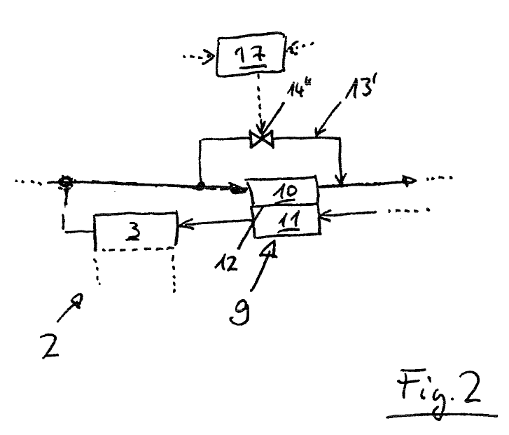

FIG. 2 a humidifier with a bypass line in an alternative arrangement.

In FIG. 1, a part of a fuel cell system 1 is shown. This comprises various components, of which only those which are relevant for the present invention are shown here in an explicit manner. This is particularly the fuel cell 2, which is typically composed as a stack of individual cells, a so-called fuel cell stack. Essentially, a cathode chamber 3 and an anode chamber 4 are present in the fuel cell 2, which are separated from one another in the example shown here by a proton-conducting membrane. Air is thereby supplied to the cathode chamber 3 as oxygen-containing medium, hydrogen for example to the anode chamber 4, which could originate from a hydrogen pressure tank. Other hydrogen sources are naturally also conceivable, as for example a gas generation system or the like.

So as to ensure the functionality of the fuel cell 2, which generates electrical power from the educts supplied thereto, a corresponding humidification of the inflowing gases has to be arranged. This humidification is explained in the example shown here by means of the gas flow flowing to the cathode 3, for example air. The humidification of the gas flow to the anode 4 is principally also conceivable in a similar manner.

The gas flow flowing to the fuel cell 2, in the following example respectively air, is passed to the fuel cell 2 by a corresponding air supply unit 6. The air supply unit can for example consist of a filter device 7 and a compressor 8, which cleans the ambient air correspondingly and conveys it to the fuel cell 2. As already described above, it is critically important for the function of the fuel cell 2 that the membrane 5 is humidified correspondingly, as drying out of the membrane 5 influences its functionality in a disadvantageous manner and the performance of the fuel cell 2 deteriorates in an extreme manner. With correspondingly dried out membranes 5, a permanent damage of the membrane 5 and thus the fuel cell 2 can result. On the other hand, the humidity present in the fuel cell 2 is not allowed to exceed a certain extent together with the product water accumulated during the reaction, as this leads to a “flooding” of the fuel cell 2, which also influences its performance in a disadvantageous manner.

The humidification of the gases supplied to the fuel cell 2, in particular of the air supplied to the fuel cell 2, is thus of critical importance. In the embodiment shown here, a humidifier 9 is thus present between the air supply unit 6 and the fuel cell 2. The humidifier 9 can thereby principally be constructed in an arbitrary manner, for example in that the air flows through a tank filled with liquid or a porous humid sponge and thereby absorbs the corresponding humidity. With fuel cell systems 1, a humidification of the type has been used in recent years where the humidifier 9 is formed as a membrane humidifier. This comprises two chambers 10, 11, which are separated from one another by a membrane 12. This membrane 12, which can for example be designed in the form of hollow fiber membranes, is impermeable to gases and liquids, but lets water vapor pass. As a humid atmosphere, e.g. in the form of a humid gas, is now present on the one side of the membrane 12 in the chamber 10, a humidification of the dry gas, here air, takes place through the membrane 12, which flows through the chamber 11. The humid gas in the chamber 10 can especially be, as optionally shown here, the humid exhaust gas exiting from the fuel cell 2.

The air flow flowing from the air supply device 6 to the fuel cell 2 preferably absorbs the humidity present in the fuel cell system 1 from the humid exhaust gas in the humidifier 9. The humidification of the air thereby typically results from the prevailing general conditions of the fuel cell system 1, which are present, as for example from the temperature, the volume flow, its pressure etc. So as to be able to adjust the humidity of the supply air in all imaginable operating states of the fuel cell 2 from completely dry, for example, at start-up or shutdown of the system, to comparatively humid, at correspondingly high performances of the fuel cell 2, the humidifier 9 or the air line comprises a bypass line 13, which is arranged in such a manner that the air can be passed around the humidifier 9 through the bypass line 13.

It is thus possible to humidify a part of the air passed to the fuel cell 2 and to pass another part through the bypass line 13 in a non-humidified manner. These two gas flows are mixed again prior to the entry into the cathode chamber 3 of the fuel cell 2, so that a gas stream having the desired humidity is adjusted during the entrance into the cathode chamber 3 of the fuel cell 2. So as to be able to regulate the gas flows through the humidifier 9 and through the bypass line 13 in a suitable manner, at least one valve 14, 14′ is arranged either in the bypass line 13 or in the guiding area which is passed by the bypass line 13. One valve 14 or 14′ is basically sufficient, but, if necessary, both valves 14 and 14′ can be present. This at least one valve 14, 14′ now permits the influencing of the volume stream, depending on the arrangement either through the humidifier 9 or through the bypass line 13. The valve 14 or the valves 14, 14′ are thereby formed as especially simple valves 14, 14′, which only know an open position and a closed position. Magnetic valves can especially be chosen for this, which can be opened and closed very simply in an electrically activated manner.

Different forms of sliders, baffles, flaps etc are thereby conceivable for the closure element for the cross section to be passed through, which are moved by (e.g. magnetic) actuators. The movement thereby always takes place from the closed position to the open position and vice versa. Intermediate positions are inevitably passed through during the movement, but these cannot be activated specifically, nor can the valve 14, 14′ be held in such an intermediate position. Actuators operated in a simple manner are thereby sufficient, which only know two digital positions (open, closed).

So as now to be able to adjust the volume flow flowing through the bypass line 13 or the humidifier 9, these valves 14, 14′ are switched in a clock form to open and dosed positions A volume flow and no volume flow are alternately generated by this clocked activation. The volume flow in the bypass line 13 and/or the humidifier 9 can thus directly be influenced in the time average, depending in which of the sections the valve 14, 14′ is arranged. The frequency of the clock rate, that is, how long the valves 14, 14′ are open or closed, thereby plays a subordinate role, as the fuel cell 2 or the humidity exchange in its membranes 5 is sufficiently inert, so as to be able to cope with dry air for a few seconds without any problems.

Regarding the possible activation of the valves 14, 14′, DE 101 60 477 A1 is also referred to, which shows these activations of actuating elements.

If only one valve 14, 14′ is present, a corresponding volume flow will adjust itself in the other branch. By the corresponding activation of the valves 14 and 14′, or in the case of one valve, 14 or 14′, the humidity can thus be adjusted in an ideal manner in the gas flow flowing to the cathode 3 of the fuel cell 2, which is mixed again after the bypass line 13.

This could basically take place via a simple control, which respectively adjusts a given humidity value at the entry into the cathode chamber 3. It is however of particular advantage, if this humidity is monitored directly or indirectly via a corresponding sensor system. All known types of humidity sensors lend themselves to the direct monitoring of the humidity. Such a sensor is shown in FIG. 1 in an exemplary manner and is provided with the reference numeral 15. Such a direct humidity measurement can for example take place via one and/or several of the sensors depicted shortly in the following.

The humidity can for example take place by the measurement of the speed of sound in the humid gases. The evaporation measurement or the evaporation method is alternatively conceivable. This is based on the principle that more water evaporates with dry ambient air compared to correspondingly humid ambient air. A psychrometer uses this possibility. This property is used thereby, and the air temperature is once measured directly, and once the temperature of a humidified temperature sensor. Hygroscopic methods are a further alternative. These methods are all based on the fact that a body (sensor) absorbs water with increasing humidity and emits it again when the humidity falls. The properties of the body change thereby, which can then be measured, for example via capacitive or ohmic sensors. Spectral methods are also conceivable. These utilize the “optical” dampening properties of the water molecules at certain spectral regions. This dampening depends on the density of the water molecules. The absorption bands are in the region of 0.7-6.2 μm. An additional version can be complementary oxygen methods. Here, the humidity content of air is determined in vol % by means of a zirconium oxide solid electrolyte sensor via -oxygen displacement or substitution by existing water vapor.

The humidity can alternatively also be determined indirectly, or one can conclude to the humidity in an indirect manner. Such an indirect conclusion to the humidity permits for example the performance of the fuel cell 2, which is better with sufficiently humidified membranes 5 than if the membranes 5 start to dry out. So as to prevent possible effects of a performance deterioration by membranes 5 which are too humid, a temperature sensor can be mounted in parallel, which permits at least rough conclusions regarding the humidity in a very simple manner via the mechanisms already explained above. A comparatively good conclusion regarding the humidity is thereby possible with the combination of both values in a simple manner.

Such an indirect monitoring device is shown here in an exemplary manner as an optional sensor with the reference numeral 16. These directly and/or indirectly determined conclusions regarding the humidity of the air supplied to the fuel cell 2 then reach a corresponding regulation unit 17, which correspondingly activates both valves 14, 14′ or the one valve 14 or 14′. As has already been mentioned, this activation can be adjusted via a pulse width modulation of the clock pause ratio or an influence of the clock frequency in such a manner that the corresponding humidity in the gas flow which is mixed again can be controlled via the regulation unit 17 or be regulated directly with corresponding sensors (e.g. with a PID regulator).

It is principally also possible to activate the two valves 14, 14′, if they are both present, in the opposite direction, so that the air flows alternately through the bypass line 13 or the humidifier 9, in a manner that the air mixed again after the bypass line 13 comprises the desired humidity. If the cross sections are thereby opened alternately in a temporal changeover, the same cross section which can be flowed through is always available in the combination of humidifier 9 and bypass line 13. Pressure pulsations in the lines after the combination can thereby be minimized or largely avoided, so that the cathode chamber 3 of the fuel cell 2 is charged with an even gas flow and possible pressure variations do not influence the further components and/or the membrane.

In addition to the assembly shown here, it is naturally also possible to integrate the valve 14′ in the humidifier 9 or arrange it behind the humidifier 9, so that the valve 14′ will end up between the humidifier 9 and the conjuncture of the line emerging from the humidifier 9 and the bypass line 13.

In addition to the above-described basic version, an alternative is shown in FIG. 2 in a section of the above FIG. 1.

This section only shows the humidifier 9 and the cathode chamber 3 of the fuel cell 2. The gas supplied to the fuel cell 2 also reaches the cathode chamber 3 of the fuel cell 2 from an air supply unit 6, not shown, through the one chamber 11 of the humidifier 9. The humidity is provided in the other chamber 10 of the humidifier 9, which humidifies the gas flow flowing to the cathode chamber 3 of the fuel cell 2 by means of the membrane 12 permeable to water vapor. This humidity can originate from different sources. It can particularly, as indicated optionally, originate again from the exhaust gas of the cathode chamber 3, which can be passed through the chamber 10 of the humidifier 9 as humidity supplier.

So as to influence the humidity of the air flow flowing to the fuel cell 2, the air flow is not divided into two branches through the humidifier 9 and around the humidifier 9, but the humid gas flow experiences this division. A part of the humid exhaust gas is thus passed around the humidifier via the bypass line 13′ shown here, so that only the necessary humidity is offered in the humidifier 9. The gas flow flowing to the fuel cell 2 is accordingly only humidified correspondingly. A valve 14″ switched in a clock form is also again arranged in the bypass line 13′, which is correspondingly controlled by the regulation unit, or analogously regulated by the embodiments shown in FIG. 1.

The principal alternative is thus shown in FIG. 2, to pass the offered humidity in a bypass line 13′ around the humidifier 9 instead of the air to be humidified, and thereby not to influence the humidification, but the offer of humidity in such a manner that the desired values adjust themselves in the air passed to the fuel cell 2.

All embodiments carried out above can naturally be used in an analogous manner in the embodiment according to FIG. 2, for example, two valves can also be provided in the bypass line 13′ and/or in the humidifier or before or after the humidifier 9, which are operated in a controlled or regulated manner as valves switched in a clock form corresponding to the above embodiments

Both described versions of the bypass line 13, 13′ can in principle be combined with one another in one assembly.

The assembly of the fuel cell system 1 in each of the described types is thereby particularly simple and efficient. It can be carried in a simple, easy and economic manner by the valves, in particular magnetic valves, which are activated in a clock form. The activation is possible in a simple and efficient manner due to measurement values which are already present in the system. A very compact, easy and economic assembly of a fuel cell system 1 can thereby be realized, which always comprises the necessary humidity in the area of the supply air. Completely non-humified air can also be provided through the bypass line 13 around the humidifier 13 and/or the bypass line 13′ of the humid air 13 around the humidifier 9 for special cases, as for example the switching on or off of the fuel cell system.

The system has naturally further components, not shown here. These can particularly be a heat exchanger, which cools the compressed and thereby typically heated air coming from the air supply device 6. Immediately in front of the fuel cell can also be present arrangements such as droplet precipitators which inhibit fluid water reaching the area of the cathode 3 of the fuel cell 2 with the air flow. But these elements are common with these systems in the meantime, so that they will not be discussed in detail.

1. An apparatus for humidifying a gas flow flowing to a fuel cell with a humidifier and a bypass line passing around the humidifier, with at least one valve for opening and closing the bypass line and/or a supply or discharge line of the humidifier between the humidifier and the bypass line, and with means for switching the valve between an open position and a closed position, wherein the at least one valve (14, 14′, 14″) can be switched in a clock form between the positions.

2. The apparatus according to claim 1, wherein the at least one valve (14, 14′, 14″) is formed as a magnetic valve.

3. A method for humidifying a gas flow flowing to a fuel cell with a humidifier and a bypass line passed around the humidifier, with at least one valve for opening and closing the bypass line and/or a supply or discharge line of the humidifier between the humidifier and the bypass line, and with means for switching the valve between an open position and a closed position wherein the at least one valve (14, 14′, 14″) is switched in a clock form between the positions.

4. The method according to claim 3, wherein the clock frequency and/or the pulse/pause ratio of the valve operation is provided in a variable manner in dependence on a parameter.

5. The method according to claim 4, wherein the parameter is in connection with the humidity content of the humidified gas.

6. The method according to claim 3, wherein at least one valve (14, 14″) is present in the bypass line (13, 13″), and a further valve (14, 14′) switched in a clock form in the area of the humidifier (9), and that both valves can be switched in a clock form in opposite directions to one another.

7. The method according to claim 6, wherein approximately the same cross section to be passed through is available in the two lines together with the valves (14, 14″) at any time of the switching in clock form in opposite directions.
